(19) United States
(12) Patent Application Publication
(10) Pub. No.: US 2023/0134263 A1
(43) Pub. Date: May 4, 2023

(54) OVERMOLDED ANTENNA RADIATOR

(71) Applicants: Martin DA SILVEIRA, Ottawa (CA); Francis MARION, Gatineau (CA); Neil MCGOWAN, Stittsville (CA)

(72) Inventors: Martin Da Silveira, Ottawa (CA); Francis Marion, Gatineau (CA); Neil McGowan, Stittsville (CA)

(73) Assignee: TELEFONAKTIEBOLAGET LM ERICSSON (PUBL), Stockholm (SE)

(21) Appl. No.: 17/912,146

(22) PCT Filed: Mar. 20, 2020
(86) PCT No.: PCT/IB2020/052627

§ 371 Date: Sep. 16, 2022

(51) Int. Cl. H01Q 21/26; H01Q 9/28

(52) U.S. Cl. CPC H01Q 21/26; H01Q 9/28

(57) ABSTRACT

Embodiments of an antenna module include first and second radiator elements separated by a gap, and a dielectric body configured to support the first and second radiator elements. The dielectric body includes at least one wall defining a cavity that encompasses a region of high electromagnetic field strength between the first and second radiator elements during operation of the antenna radiator.

### TECHNICAL FIELD

The present disclosure relates to wireless communications antennas, and more particularly to an overmolded Advanced Antenna System (AAS) Antenna Radiator.

### BACKGROUND

A conventional Advanced Antenna System (AAS) typically comprises a plurality of antenna modules arranged in a rectangular array. Each antennal module normally includes two or more metallic strips that are commonly secured together by some combination of screws, rivets and/or plastic clips. These metallic strips are electrically connected to radio frequency (RF) driver circuitry and server to radiate (and receive) RF energy into (and from) the space around the AAS.

The use of screws, rivets and plastic clips to secure the metallic strips suffers from poor precision and repeatability. As a result, each antenna module must be individually calibrated, and the RF driver circuitry adjusted in accordance with the calibration, in order to achieve desired antenna performance. This significantly increases the cost of the antenna module.

Overmolding is a known technique that may be used as an alternative to the use of screws, rivets and plastic clips to secure the metallic strips. In this case, the metallic strips are placed within an injection mold and liquid resin injected into the mold. When the resin hardens the completed antenna module can be removed from the mold. U.S. Pat. No. 6,285,324 provides an example of an antenna package formed by such an overmolding technique. Depending on the design of the injection mold, high precision and repeatability can be obtained. However, the dielectric properties of the resin are an important factor limiting the performance of the antenna module. In many cases, the resin material is selected based on a compromise between dielectric and mechanical properties. For example, reduced RF performance may have to be accepted in order to obtain satisfactory mechanical properties such as stiffness, strength and dimensional stability (especially under conditions of changing temperature).

Improved techniques that enable highly precise and repeatable placement of metallic elements in an AAS antenna module remain highly desirable.

### SUMMARY

An object of the present disclosure is to provide improved techniques that overcome at least some of the above-noted deficiencies in the prior art.

Accordingly, an aspect of the present disclosure provides an antenna module comprising first and second radiator elements separated by a gap, and a dielectric body configured to support the first and second radiator elements. The dielectric body includes at least one wall defining a cavity that encompasses a region of high electromagnetic field strength between the first and second radiator elements during operation of the antenna radiator.

In some embodiments the cavity corresponds with a gap between the first and second radiator elements.

In some embodiments the dielectric body partially, but not completely, fills the gap between the first and second radiator elements.

In some embodiments each of the first and second radiator elements comprises a respective feed strip. The gap between the first and second radiator elements may comprise a predetermined gap between the respective feed strip of each radiator element.

In some embodiments each of the first and second radiator elements comprises a respective radiator leaf. The gap between the first and second radiator elements may comprise a predetermined gap between the respective radiator leaf of each radiator element.

In some embodiments the dielectric body is overmolded on the at least two radiator elements.

In some embodiments at least one of the radiator elements comprises a tab disposed in a region of low electromagnetic field strength between the at least two radiator elements during operation of the antenna radiator. The tab may be configured to engage the dielectric body so as to fix a position of the radiator element relative to the dielectric body.

Embodiments of an Advanced Antenna System (AAS), and manufacturing methods are also disclosed.

An advantage of the present disclosure is that the cavity renders the RF performance of the antenna module highly insensitive to the dielectric properties (such as, for example, dielectric constant, permittivity, dielectric dispersion and dielectric relaxation) of the dielectric body material. As a result, the dielectric body material can be selected based on its molding and mechanical properties. In some embodiments, lower cost materials can be used to form the dielectric body than would be practical in conventional overmolded antenna modules. In some embodiments, superior RF performance can be obtained as compared to conventional overmolded antenna modules.

### BRIEF DESCRIPTION OF THE DRAWINGS

The accompanying drawing figures incorporated in and forming a part of this specification illustrate several aspects of the disclosure, and together with the description serve to explain principles of the disclosure.

FIGS. 1A-1E illustrate example features of an overmolded antenna module in accordance with a representative embodiment of the present disclosure, wherein: FIG. 1A is a perspective view showing the assembled antenna module; FIG. 1B is a perspective view showing radiator elements of the antenna module configured as a dipole radiator; FIG. 1C is a cross sectional view of the antenna module taken along line A-A in FIG. 1A; and FIGS. 1D and 1E are alternative cross sectional views of the antenna module taken along line B-B in FIG. 1A;

FIGS. 2A-2E illustrate example features of an overmolded antenna module in accordance with a second representative embodiment of the present disclosure, wherein: FIG. 2A is a perspective view showing the assembled antenna module; FIG. 2B is a top view of the assembled antenna module; FIG. 2C is a perspective view showing radiator elements of the antenna module configured as a cross-polarized dipole radiator; FIG. 2D is a cross sectional view of the antenna module taken along line A-A in FIG. 2A; and FIG. 2E is a cross sectional view of the antenna module taken along line B-B in FIG. 2A;

FIGS. 3A-3B illustrate example features of an overmolded antenna module in accordance with a third representative embodiment of the present disclosure, wherein: FIG. 3A is a perspective view showing the assembled antenna module; and FIG. 3B is a top view of the assembled antenna module;

FIG. 4 is a perspective view showing features of radiator elements usable in embodiments of the present disclosure; and

FIGS. 5A-5B illustrate example features of an overmolded antenna module in accordance with a further representative embodiment of the present disclosure, wherein: FIG. 5A is a perspective view showing the assembled antenna module; and FIG. 5B is a top view of the assembled antenna module;

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

The embodiments set forth below illustrate various combinations of example features that may be implemented in accordance with the present disclosure. It should be understood that the illustrated features are not restricted to any particular embodiment, but rather the various disclosed features may be used alone or in any suitable combination to satisfy the performance requirements of any particular antenna module.

At least some of the following abbreviations and terms may be used in this disclosure.
2D Two Dimensional
3GPP Third Generation Partnership Project
5G Fifth Generation
AAS Antenna Array System
AoA Angle of Arrival
AoD Angle of Departure
ASIC Application Specific Integrated Circuit
BF Beamforming
BLER Block Error Rate
BW Beamwidth
CPU Central Processing Unit
CSI Channel State Information
dB Decibel
DCI Downlink Control Information
DFT Discrete Fourier Transform
DSP Digital Signal Processor
eNB Enhanced or Evolved Node B
FIR Finite Impulse Response
FPGA Field Programmable Gate Array
gNB New Radio Base Station
ICC Information Carrying Capacity
IIR Infinite Impulse Response
LTE Long Term Evolution
MIMO Multiple Input Multiple Output
MME Mobility Management Entity
MMSE Minimum Mean Square Error
MTC Machine Type Communication
NR New Radio
OTT Over-the-Top
PBCH Physical Broadcast Channel
PDCCH Physical Downlink Control Channel
PDSCH Physical Downlink Shared Channel
P-GW Packet Data Network Gateway
RAM Random Access Memory
ROM Read Only Memory
RRC Radio Resource Control
RRH Remote Radio Head
SCEF Service Capability Exposure Function
SINR Signal to Interference plus Noise Ratio
TBS Transmission Block Size
UE User Equipment
ULA Uniform Linear Array
URA Uniform Rectangular Array

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting (and/or receiving) signals to (and/or from) a radio access node. Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Cell: As used herein, a “cell” is a combination of radio resources (such as, for example, antenna port allocation, time and frequency) that a wireless device may use to exchange radio signals with a radio access node, which may be referred to as a host node or a serving node of the cell. However, it is important to note that beams may be used instead of cells, particularly with respect to 5G NR. As such, it should be appreciated that the techniques described herein are equally applicable to both cells and beams.

Note that references in this disclosure to various technical standards (such as 3GPP TS 38.211 V15.1.0 (2018-03) and 3GPP TS 38.214 V15.1.0 (2018-03), for example) should be understood to refer to the specific version(s) of such standard(s) that is(were) current at the time the present application was filed, and may also refer to applicable counterparts and successors of such versions.

The description herein focuses on a 3GPP cellular communications system and, as such, 3GPP terminology or terminology similar to 3GPP terminology is oftentimes used. However, the concepts disclosed herein are not limited to a 3GPP system.

Apparatus and methods are disclosed herein that provide an antenna module comprising first and second radiator elements, and a dielectric body configured to support the first and second radiator elements. The dielectric body includes at least one wall defining a cavity corresponding to a region of high electromagnetic field strength between the first and second radiator elements during operation of the antenna radiator.

In some embodiments the cavity corresponds with a gap between the first and second radiator elements.

In some embodiments the dielectric body partially, but not completely, fills the gap between the first and second radiator elements.

In some embodiments each of the first and second radiator elements comprises a respective feed strip. The gap between the first and second radiator elements may comprise a predetermined gap between the respective feed strip of each radiator element.

In some embodiments each of the first and second radiator elements comprises a respective radiator portion. The gap between the first and second radiator elements may comprise a predetermined gap between the respective radiator portion of each radiator element.

In some embodiments the dielectric body is overmolded on the at least two radiator elements.

In some embodiments at least one of the radiator elements comprises a tab disposed in a region of low electromagnetic field strength between the at least two radiator elements during operation of the antenna radiator. The tab may be configured to engage the dielectric body so as to fix a position of the radiator element relative to the dielectric body.

Embodiments of an Advanced Antenna System (AAS), and manufacturing methods are also disclosed.

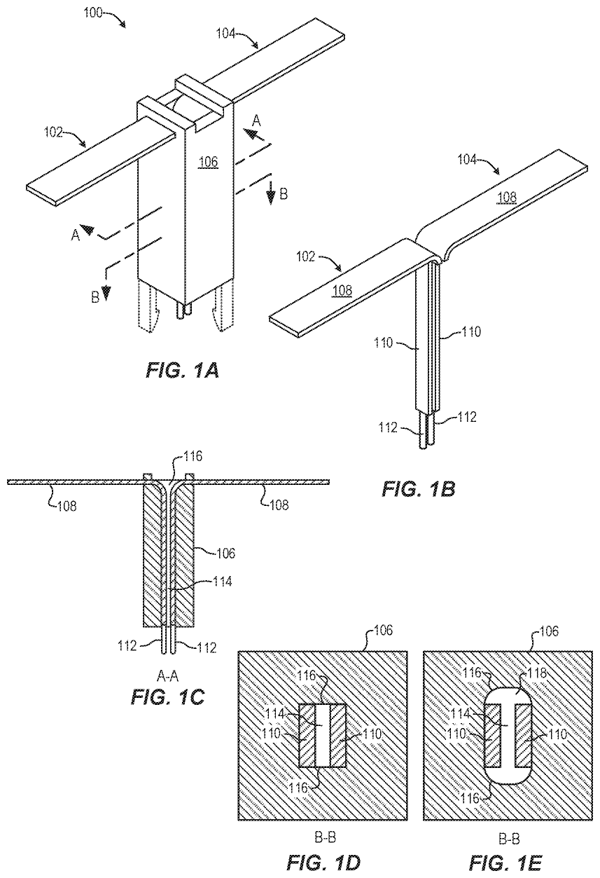

FIGS. 1A-1D illustrate example features of an overmolded antenna module 100 in accordance with a representative embodiment of the present disclosure. FIG. 1A is a perspective view showing the assembled antenna module 100. As may be seen in FIG. 1A, the antenna module 100 includes a first radiator element 102, a second radiator element 104, and a dielectric body 106. In the illustrated example, the radiator elements 102,104 may be composed of rectangular metallic strips arranged to form a simple dipole.

FIG. 1B is a perspective view showing the radiator elements 102, 104 of the antenna module 100 in greater detail. In the illustrated example, each radiator element 102,104 comprises a radiator portion 108 electrically connected to a feed-strip 110 which is adapted to electrically connect the radiator portion 108 to a radio frequency (RF) driver circuit (not shown). In the illustrated example, each feed-strip 110 includes a terminal 112 such as a pin, for example, which may be used to connect the feed strip 110 to a circuit trace on a Printed Circuit Board (PCB). For example, a terminal 112 in the form of a pin may be used for connecting the feed strip 110 to a circuit trace by means of a conventional solder connection. Alternatively, contact pads may be used instead of pins to connect the feed strip 110 to a circuit trace on a PCB by means of known surface mount techniques. In a still further alternative, the terminal 112 may be configured as a contact blade or the like which, in cooperation with the dielectric body 106, may be configured to engage a socket or plug mounted on a PCB, so that the antenna module 100 can be removably connected to the PCB. in yet another embodiment, the terminal 112 may be configured to form a capacitive coupling with a circuit trace or conductive region on a PCB.

FIG. 1C is a cross sectional view of the antenna module 100 taken along line A-A in FIG. 1A, and FIGS. 1D and 1E are alternative cross sectional views of the antenna module 100 taken along line B-B in FIG. 1A. As may be seen in FIGS. 1C-1E, the feed strips 110 of each radiator element 102, 104 are arranged parallel to each other, and spaced apart by a predetermined gap having dimensions that are selected to achieve desired RF performance of the assembled antenna module 100. Those of ordinary skill in the art will appreciated that in operation of the antenna module 100, the RF driver circuit (not shown) may differentially drive each radiator element 102, 104, which means that different voltages will be applied to the terminal 112 of each feed strip 110. This may induce a relatively high RF electromagnetic field in the gap 114 between the two feed strips 110.

For the purposes of the present disclosure, the term “relatively high RF electromagnetic field”, and similar terms, should be understood to mean a RF electromagnetic field of sufficient intensity that the dielectric properties of material(s) intersected by that electromagnetic field will affect the performance of the antenna module 100. In the illustrated example embodiments, the volume of space corresponding to the gap 114 between the two feed strips 110 will be intersected by a relatively high RF electromagnetic field, and thus the dielectric properties of material(s) in this space will affect the overall performance of the antenna module 100. On the other hand, the RF electromagnetic field intensity outside of the gap 114 will be of relatively low intensity, such that the dielectric properties of material(s) in this space will have very little effect on the overall performance of the antenna module 100.

Dielectric properties of numerous materials have been studied extensively, and thus will not be described in detail herein. For the purposes of the present disclosure, the term “dielectric properties” shall be understood to refer to any properties of a material that may affect the propagation of electromagnetic energy through the material. Example dielectric properties include, but are not limited to, dielectric constant, permittivity, dielectric dispersion and dielectric relaxation.

In accordance with embodiments of the present disclosure, the dielectric body 106 includes one or more walls 116 that define a cavity 118 that encompasses a region of high electromagnetic field strength between the first and second radiator elements 102 and 104 during operation of the antenna module 100. In the embodiment of FIG. 1D, the region of high electromagnetic field strength between the first and second radiator elements during operation of the antenna radiator corresponds with the gap 114 between the two feed strips 110, and the walls 116 are configured such that the cavity 118 is coextensive with the gap 114 between the two feed strips 110. FIG. 1E shows an alternative embodiment in which the walls 116 are configured such that the cavity 118 is larger than (and includes) the gap 114 between the two feed strips 110.

In the illustrated example embodiments, the feed strips of each radiator element are formed with a rectangular cross section. It will be appreciated that the feed strips 110 can have any desired cross-sectional shape, including rectangular, square, circular, elliptical, triangular etc.

In the illustrated embodiments, the cavity 118 is preferably filled with air (or vacuum, in the case of a space-based antenna system), so the dielectric properties of air will dominate the propagation of RF electromagnetic fields within the region of high RF electromagnetic field. If desired, the cavity 118 may be filled with a different dielectric material (such as Polytetrafluoroethylene—PTFE, for example) in which case the propagation of RF electromagnetic fields within the cavity 118 (and thus in the region of high RF electromagnetic field) will be dominated by the dielectric properties of that material.

An important advantage of the embodiments described in the present disclosure is that, because the cavity 118 encompasses a region of high electromagnetic field strength between the first and second radiator elements 102 and 104, the overall RF performance of the antenna module 100 is highly insensitive to the dielectric properties of the material(s) used to form the dielectric body 106. Consequently, the dielectric properties of the material(s) used to form the dielectric body 106 may be less important that other properties of the material(s) under consideration. In some cases, this means that the material(s) used to form the dielectric body 106 may be selected based primarily on mechanical properties such as strength, stiffness, dimensional stability and resistance to weathering, for example. In some cases, the material(s) used to form the dielectric body 106 may be selected based primarily on manufacturing considerations, such as the ease of injection molding. In some cases, lower-cost materials, such as high molecular weight polyethylene, may be selected to form the dielectric body 106.

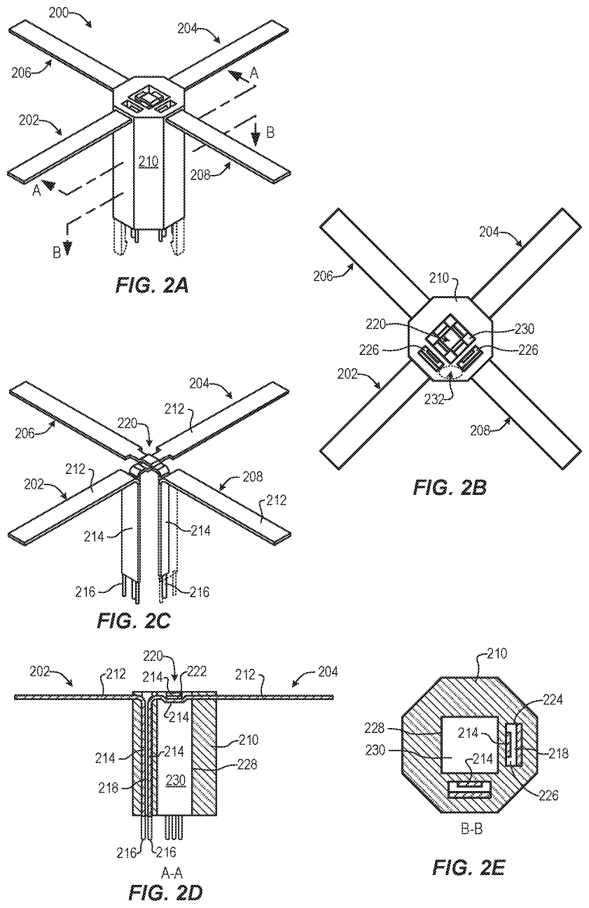

FIGS. 2A-2E illustrate example features of an overmolded antenna module 200 in accordance with a second representative embodiment of the present disclosure. As may be seen in FIGS. 2A-2C, the illustrated example antenna module 200 includes four radiator elements 202-208 arranged to form a pair of cross-polarized dipoles, and a dielectric body 210. A first dipole is formed by radiator elements 202 and 204, while a second dipole is formed by radiator elements 206 and 208. As in the example embodiments of FIGS. 1A-1E, each radiator element 202-208 may be formed of a rectangular metallic strip and includes a radiator portion 212 and a feed strip 214 having a terminal 216 configured to connect the feed strip 214 to an RF driver circuit (not shown). Within each dipole, the respective feed strips 214 of each radiator element 202-208 are arranged parallel to each other and separated by a gap 218, in a manner closely similar to that described above with reference to FIGS. 1A-1E. The only significant difference being that in the example of FIGS. 2A-2E, the respective feed strips 214 of the two involved radiator elements (forming a given dipole) have different widths.

In order to permit assembly of the cross-polarized antenna module 200, respective feed strips 214 of two of the radiator elements (one radiator element from each dipole) form a cross-over bridge 220 near the center of the antenna module 200. For example, in the embodiment of FIGS. 2A-2E, the respective feed strips 214 of radiator elements 202 and 204 form a cross-over bridge 220. Within this cross-over bridge 220, the feed strips 214 of the two involved radiator elements (e.g. radiator elements 202 and 204) are also separated by a gap 222 having dimensions selected to obtain desired RF performance of the antenna module 200.

The volumes of space corresponding to the gaps 218 and 222 may be intersected by a relatively high RF electromagnetic fields, and thus the dielectric properties of any material in these spaces will affect the overall performance of the antenna module 200. On the other hand, the RF electromagnetic field intensity outside of the gaps 218 and 222 will be of relatively low intensity, such that the dielectric properties of any material in this space will have very little effect on the overall performance of the antenna module 200.

In accordance with embodiments of the present disclosure, the dielectric body 210 includes one or more walls that define a cavity that encompasses a region of high electromagnetic field strength between the first and second radiator elements during operation of the antenna module 200. In the embodiment of FIGS. 2A-2E, a first set of one or more walls 224 define a first cavity 226 that encompasses the gap 218 between the first and second radiator elements of each dipole (i.e. elements 202 and 204, and elements 206 and 208) in a manner similar to that described above with reference to FIGS. 1A-1E. In addition, the embodiment of FIGS. 2A-2E also includes a second set of one or more walls 228 that define a second cavity 230 that encompasses the gap 222 between the first and second radiator elements of cross-over bridge 220 (i.e. elements 204 and 206). In the example of FIGS. 2A-2E, the second cavity 230 is very much larger than the gap 222, and in fact encompasses an entire central region of the dielectric body 210. Such an enlarged cavity does not affect the RF performance of the antenna module 200, but may facilitate the manufacturing process by simplifying the molds needed to form the dielectric body 210.

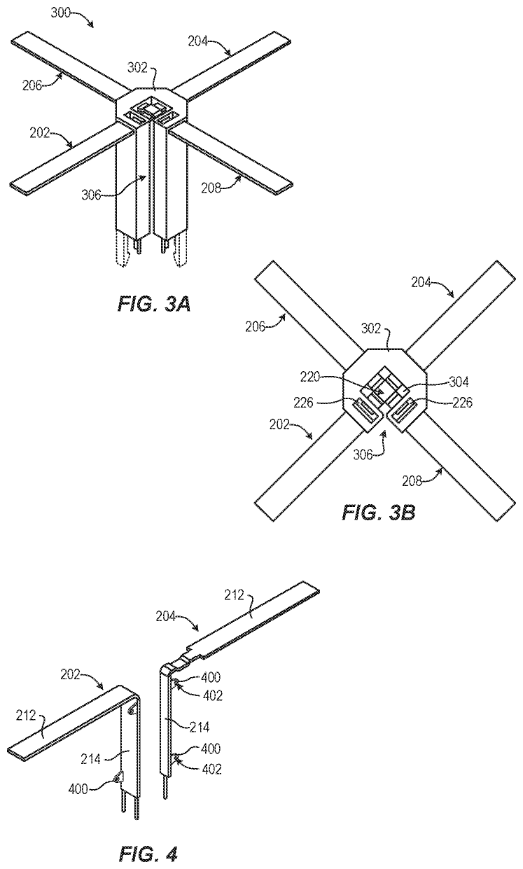

FIGS. 3A-3B illustrate example features of an overmolded antenna module 300 in accordance with a third representative embodiment of the present disclosure. The example embodiment of FIGS. 3A and 3B is closely similar that of FIGS. 2A-2B except that the second (central) cavity 304 encompassing the cross-over bridge 220 extends to a wedge-shaped cut-out portion 306 located between the feed-strips 214 of the antenna elements 202-208.

As may be appreciated, the two dipoles (202-204 and 206-208) can be driven using different RF signals, and this can lead to electromagnetic coupling between the two dipoles (202-204 and 206-208) and thus the formation of relatively high RF electromagnetic fields between the feed-strips 214 of each dipole. In the embodiment of FIGS. 2A-2E, the presence of material of the dielectric body 210 in this region (indicated at 232 in FIG. 2B) may increase electromagnetic coupling between the two dipoles (202-204 and 206-208) and degrade overall performance of the antenna module 200. The wedge-shaped cut-out portion 306 minimizes this problem by minimizing the amount of material of the dielectric body 302 in this region between the two dipoles. In order to preserve required structural properties of the dielectric body 302, it may be necessary for at least some material of the dielectric body 302 to extend into the region intersected by the RF electromagnetic fields between the feed-strips 214 of each dipole. However, the wedge-shaped cut-out portion 306 enables the amount of material of the dielectric body to be minimized in this region, and so minimizes the effect of the dielectric properties of the dielectric body material on the RF performance of the antenna module 300.

In the embodiments described above, the dielectric body includes at least one wall defining a cavity that encompasses a region of high RF electromagnetic field during operation of the antenna module. In the embodiments of FIGS. 1 and 2, each cavity is configured to almost completely exclude material of the dielectric body from region(s) of high RF electromagnetic field. In the embodiment of FIG. 3, a cavity 304 is configured such that a region of high RF electromagnetic field is partially, but not completely, filled with material of the dielectric body. In all cases, the cavity is configured to minimize the amount of material of the dielectric body in a region of high RF electromagnetic field, which serves to minimize the effect of the dielectric properties of the material of the dielectric body on the RF performance of the antenna module.

As may be appreciated, the absence of material of the dielectric body from regions of high RF electromagnetic field can result in the antenna elements 102, 104, and 202-208 being inadequately supported. This can result in a loss of precision and/or repeatability in the position of each antenna element within an antenna module 100, 200, 300. The embodiments of FIGS. 1-3 illustrate various strategies for retaining antenna elements in place, particularly by providing portions of the dielectric body that wrap around the antenna elements outside of regions of high RF electromagnetic field, and thereby capture the antenna elements. FIG. 4 illustrates an alternative approach, in which an antenna element is provided with structures such as tabs that extend outside of regions of high RF electromagnetic field, and that are designed to mechanically engage the dielectric body. For example, in FIG. 4, the illustrated antenna elements 202 and 204 are provided with tabs 400, each of which includes a through-hole 402. During the overmolding process, dielectric resin flows around the tabs 400 and into the through-holes 402. When the resin solidifies, the tabs 400 (and thus the antenna elements) are permanently held in place by the surrounding dielectric body material. If desired, the radiator portion and/or feed strip of one or more antenna elements may be provided with other structures such as indents or through-holes (not shown) designed to mechanically engage the dielectric body material during the overmolding process. Such structures may serve to further improve precision and/or repeatability in the position of each antenna element within an antenna module.

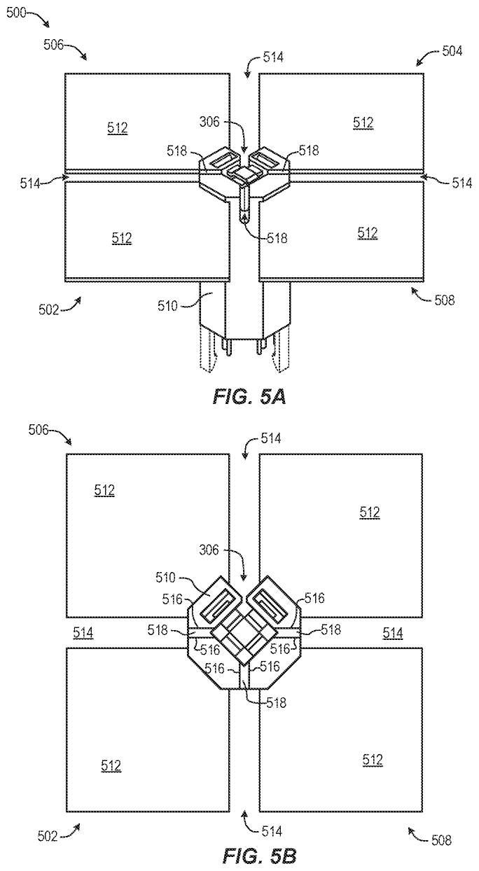

FIGS. 5A-5B illustrate example features of an overmolded antenna module 500 in accordance with a further representative embodiment of the present disclosure. The embodiment of FIGS. 5A and 5B is closely similar to the embodiment of FIGS. 3A and 3B, except that the radiator portion 512 of each antenna element 502-508 has a broadened rectangular form. This rectangular form produces relatively narrow gaps 514 between the respective radiator portions 512 of adjacent antenna elements, and relatively high RF electromagnetic fields may appear in the vicinity of these gaps during operation of the antenna module 500.

In accordance with embodiments of the present disclosure, the dielectric body 510 includes one or more walls 516 that define a cavity 518 in each region of high RF electromagnetic field strength between adjacent radiator elements during operation of the antenna module 500. As with the wedge-shaped cut-out portion 306 described above, the cavities 518 do not exclude all material of the dielectric body from the region of high RF electromagnetic field strength (i.e. the gaps 514). However, the cavities 518 do minimize the amount of material of the dielectric body 510 that is in the region of high RF electromagnetic field strength. This arrangement is beneficial in that it minimizes the effect of the dielectric properties of the material of the dielectric body 510, while ensuring adequate structural support for each antenna element 502-508.

While processes in the figures may show a particular order of operations performed by certain embodiments of the present disclosure, it should be understood that such order is representative, and that alternative embodiments may perform the operations in a different order, combine certain operations, overlap certain operations, etc.

Those skilled in the art will recognize improvements and modifications to the embodiments of the present disclosure. All such improvements and modifications are considered within the scope of the concepts disclosed herein.

What is claimed is:

1. An antenna module comprising:
first and second radiator elements separated by a gap; and
a dielectric body configured to support the first and second radiator elements, the dielectric body including at least one wall defining a cavity that encompasses a region of high electromagnetic field strength between the first and second radiator elements during operation of the antenna radiator.

2. The antenna module as claimed in claim 1, wherein the cavity corresponds with the gap between the first and second radiator elements.

3. The antenna module as claimed in claim 2, wherein material of the dielectric body partially, but not completely, fills the gap between the first and second radiator elements.

4. The antenna module as claimed in claim 2, wherein each of the first and second radiator elements comprises a respective feed strip, and wherein the gap between the first and second radiator elements comprises a gap between the respective feed strip of each radiator element.

5. The antenna module as claimed in claim 2, wherein each of the first and second radiator elements comprises a respective radiator portion, and wherein the gap between the first and second radiator elements comprises a gap between the respective radiator portion of each radiator element.

6. The antenna module as claimed in claim 1, wherein the dielectric body is overmolded on the at least two radiator elements.

7. The antenna module as claimed in claim 1, wherein at least one of the radiator elements comprises a tab disposed in a region of low electromagnetic field strength between the at least two radiator elements during operation of the antenna radiator, the tab configured to engage the dielectric body so as to fix a position of the radiator element relative to the dielectric body.

8. The antenna module as claimed in claim 1, wherein the cavity is filled with air.

9. The antenna module as claimed in claim 1, wherein the cavity is filled with a dielectric material having dielectric properties different than the dielectric properties of the dielectric body.

10. The antenna module as claimed in claim 9, wherein the dielectric material comprises polytetrafluoroethylene.

11. The antenna module as claimed in claim 9, wherein the dielectric material comprises air.
